(19) United States
(12) Patent Application Publication
(10) Pub. No.: US 2023/0158801 A1
(43) Pub. Date: May 25, 2023

(54) EXPANSION MEMBERS

(71) Applicant: Hewlett-Packard Development Company, L.P., Spring, TX (US)

(72) Inventors: Douglas Richards, Boise, ID (US); Jeffrey Luke, Boise, ID (US)

(21) Appl. No.: 17/908,688

(22) PCT Filed: Mar. 10, 2020
(86) PCT No.: PCT/US2020/021801

§ 371 Date: Sep. 1, 2022

(51) Int. Cl. B41J 2/175; G03G 21/16; G03G 21/18

(52) U.S. Cl. CPC B41J 2/17526; B41J 2/17546; G03G 21/186; G03G 21/1647; G03G 21/1846

(57) ABSTRACT

In some examples, an apparatus can include a drive shaft, a compression flange, an expansion member located proximate to the compression flange, and a compression mechanism, where the compression mechanism is to cause the expansion member to expand from a first diameter to a second diameter when the compression mechanism moves from a disengaged position to an engaged position.

### BACKGROUND

Imaging systems, such as printers, copiers, scanners, etc., may be used to scan a physical medium to capture and/or record information included on the physical medium, form markings on a physical medium, such as text, images, etc. In some examples, imaging systems may scan a physical medium and/or form markings on a physical medium by performing a job. In some examples, the job can be a scan job that can include scanning a physical medium optically to capture and/or record information included on the physical medium. In some examples, the job can be a print job that can include forming markings such as text and/or images by transferring a print material such as toner to a physical medium.

### BRIEF DESCRIPTION OF THE DRAWINGS

FIG. 1 is a side view of an example of an apparatus having an expansion member consistent with the disclosure.

FIG. 2A is a side view of an example of an apparatus having an expansion member and a cam in a disengaged position consistent with the disclosure.

FIG. 2B is a side view of an example of an apparatus having an expansion member and a cam in an engaged position consistent with the disclosure.

FIG. 3A is a side view of an example of an apparatus having an expansion member and a solenoid in a disengaged position consistent with the disclosure.

FIG. 3B is a side view of an example of an apparatus having an expansion member and a solenoid in an engaged position consistent with the disclosure.

FIG. 4A is a side view of an example of an apparatus having an expansion member, a lever, and a solenoid in a disengaged position consistent with the disclosure.

FIG. 4B is a side view of an example of an apparatus having an expansion member, a lever, and a solenoid in an engaged position consistent with the disclosure.

FIG. 5 is a side section view of an example of a portion of an imaging device having an expansion member consistent with the disclosure.

FIG. 6A is a perspective view of an example of an apparatus having an expansion member and a compression nut in a disengaged position consistent with the disclosure.

FIG. 6B is a perspective view of an example of an apparatus having an expansion member and a compression nut in an engaged position consistent with the disclosure.

FIG. 7A is a side view of an example of an apparatus having a drive shaft with a tapered diameter and an expansion member consistent with the disclosure.

FIG. 7B is a side view of an example of an apparatus having a drive shaft with a tapered diameter and an expansion member consistent with the disclosure.

FIG. 8 is a perspective view of an apparatus having a cartridge flange and a grip structure consistent with the disclosure.

FIG. 9A is a side section view of an example of a system consistent with the disclosure.

FIG. 9B is a side section view of an example of a system consistent with the disclosure.

FIG. 10 is a perspective view of an example of a grip structure including a circular reception member consistent with the disclosure.

FIG. 11 is a perspective view of an example of a grip structure including a semi-circular reception member consistent with the disclosure.

FIG. 12 is a perspective view of an example of a grip structure including a plurality of semi-circular reception members consistent with the disclosure.

FIG. 13 is a perspective view of an example of a grip structure including a plurality of circular extruded members consistent with the disclosure.

FIG. 14 is a perspective view of an example of a grip structure including a plurality of triangular extruded members consistent with the disclosure.

### DETAILED DESCRIPTION

Imaging devices may perform print jobs using physical media. For example, a print job may include forming text and/or images on physical media, such as a physical print medium. In some examples, a “medium” may include paper, cloth, plastics, composite, metal, substrates, or the like and/or combinations thereof. As used herein, the term “imaging device” refers to any hardware device with functionalities to physically produce representation(s) on a physical print medium. For example, the imaging device can be a laser printer, among other examples.

In some examples, an imaging device may utilize a print cartridge having a drive mechanism to form text and/or images on the physical media. As used herein, the term “print cartridge” refers to a container including print material. For example, the print cartridge can include toner to form text and/or images on physical media during a print job.

The print cartridge may be rotated during a print job process in order to form text and/or images on physical media. For example, the imaging device may include a drive mechanism such as a motor and a gear system that can interface with the print cartridge to rotate the cartridge during the print job.

Print cartridges may be removed from the imaging device. For example, print cartridges may be removed for maintenance, replacement, cleaning, among other examples. However, alignment of the print cartridge with the gear system during replacement of a print cartridge may be difficult.

Expansion members, according to the disclosure, can allow for an expansion member in an imaging device to expand from a first diameter to a second diameter to engage with a grip structure on a print cartridge for a simple and effective drive system for a print cartridge. The friction fit between the expansion member and the grip structure can allow the imaging device to rotate the print cartridge during a print job. Alignment between the grip structure of the print cartridge and the expansion member can be simplified relative to previous approaches utilizing a gear system, dongle gears, and/or other various twisted prism and/or lobbed drive approaches, providing for an easy-align system with lower force for a user to install the print cartridge. Further, situations in which a jam in the drive mechanism damaging the print cartridge can be reduced, as the friction fit between the expansion member and the grip structure can be specified such that the expansion member can slip relative to the grip structure when a threshold torque is exceeded.

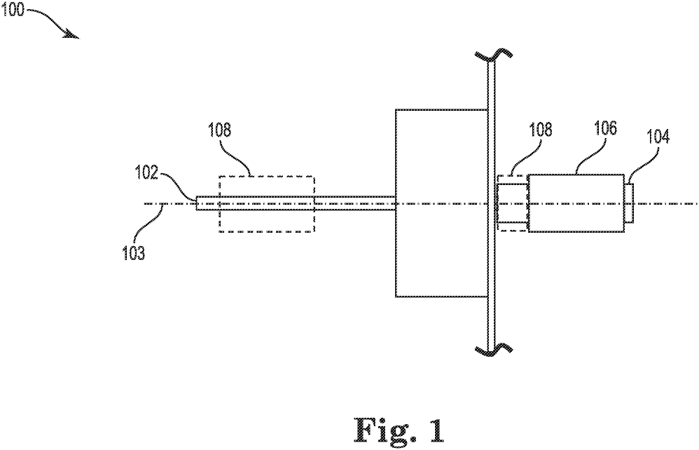

FIG. 1 is a side view of an example of an apparatus 100 having an expansion member 106 consistent with the disclosure. The apparatus 100 can include a drive shaft 102, a compression flange 104, an expansion member 106, and a compression member 108. The drive shaft 102 can include an axis 103.

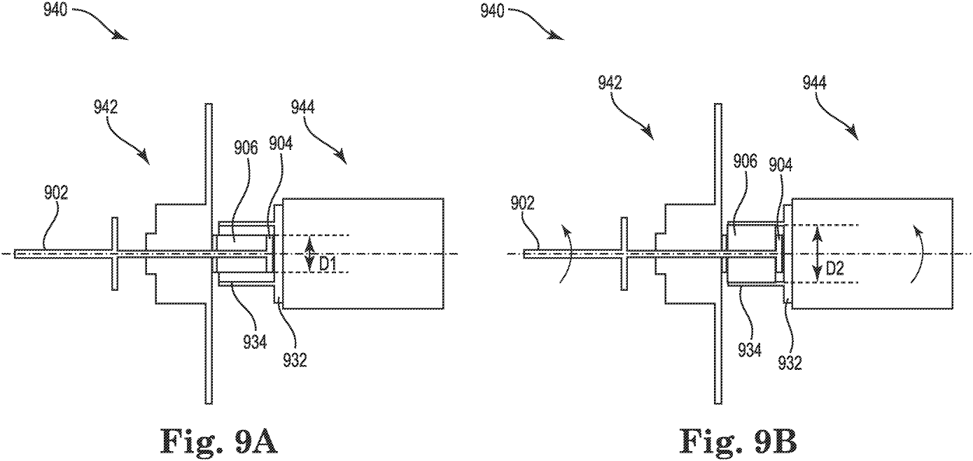

The apparatus 100 can be included in an imaging device. For example, an imaging device can utilize the apparatus 100 to rotate a print cartridge during a print job, as is further described in connection with FIG. 9.

The apparatus 100 can include a drive shaft 102. As used herein, the term “drive shaft” refers to a mechanical component to transmit torque and rotation. For example, the apparatus 100 can utilize the drive shaft 102 to transmit torque to rotate a print cartridge during a print job. The drive shaft 102 can include axis 103. The drive shaft 102 can rotate about the axis 103.

The apparatus 100 can include a compression flange 104. As used herein, the term “flange” refers to a projecting collar from another piece of material. For example, the compression flange 104 can be a projecting collar from a piece of material. The compression flange 104 can be utilized in conjunction with a compression mechanism 108 in order to axially compress the expansion member 106 to cause the expansion member 106 to expand, as is further described herein. In some examples, the compression flange 104 can be connected to the drive shaft 102. In some examples, the compression flange 104 ca be connected to an intermediary piece (e.g., not illustrated in FIG. 1).

As illustrated in FIG. 1, the apparatus 100 can include the expansion member 106. As used herein, the term “member” refers to a constituent component of a composite whole. The expansion member 106 can, when compressed axially, expand its diameter. For example, the expansion member 106 can compressed such that its diameter expands from a first diameter (e.g., as illustrated in FIG. 1) to a second diameter which is larger than the first diameter, as is further described herein.

Although the expansion member 106 is illustrated in FIG. 1 as a cylindrical shape having a circular cross section, examples of the disclosure are not so limited. For example, the expansion member 106 can include a square cross section, rectangular cross section, triangular cross section, irregular cross section (e.g., gear shaped), and/or combinations thereof (e.g., different portions of the expansion member 106 having different cross sections).

As described above, in some examples, the expansion member 106 can include an irregular shaped cross section. The irregular shaped cross section can include, for instance, a gear shape. The gear shaped expansion member 106 can include, for example, a spur gear, helical gear, bevel gear, and/or other gear-shaped cross section. In an example of the expansion member 106 having a spur gear cross section, the gear teeth can be triangular, rectangular, square, trapezoidal, saw-tooth shaped, and/or other shapes that can result in volute or involute gear teeth.

The expansion member 106 can be of a material that when compressed axially, allows it to expand its diameter. Additionally, the expansion member 106 can be a material selected based on its friction coefficient and/or its durometer hardness. For example, the expansion member 106 can be a rubber elastomer, urethane, silicone, and/or any other polymer or elastomer.

The expansion member 106 can be located proximate to the compression flange 104. For example, the expansion member 106 can be compressed by a compression mechanism 108 axially using the compression flange 104, as is further described herein.

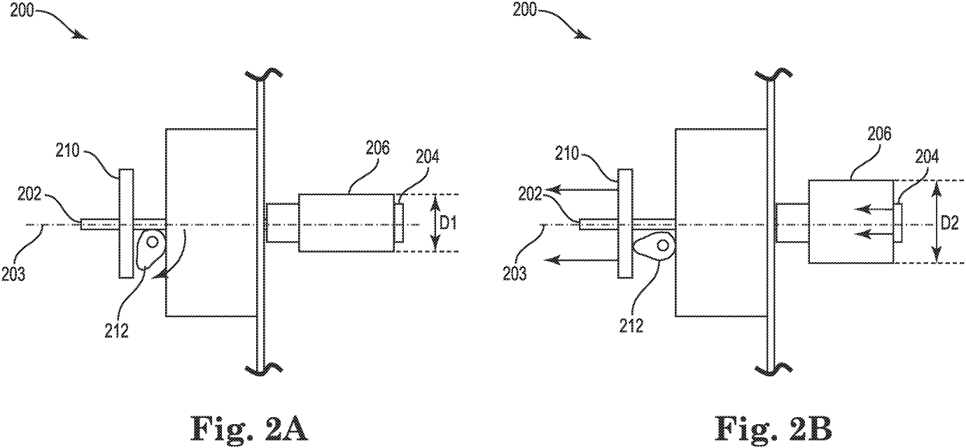

The apparatus 100 can include a compression mechanism 108. As used herein, the term “compression mechanism” refers to at least one part intended to accomplish a purpose. For example, the compression mechanism 108 can comprise various parts in order to cause the expansion member 106 to expand from a first diameter to a second diameter. For instance, the compression mechanism 108 can include a cam, a solenoid, a solenoid and a lever, a compression nut, and/or a tapered drive shaft, as is further described herein with respect to FIGS. 2-7.

As illustrated in FIG. 1, the drive shaft 102, the compression flange 104, and the expansion member 106 can be coaxially located relative to each other. For example, the drive shaft 102, the compression flange 104, and the expansion member 106 can be coaxially located with the axis 103.

FIG. 2A is a side view of an example of an apparatus 200 having an expansion member 206 and a cam 212 in a disengaged position consistent with the disclosure. The apparatus 200 can include a drive shaft 202, a compression flange 204, an expansion member 206, a shaft flange 210, and a cam 212. The drive shaft 202 can include an axis 203.

As illustrated in FIG. 2A, the compression mechanism (e.g., compression mechanism 108, previously described in connection with FIG. 1) can be a shaft flange 210 and cam 212. As used herein, the term “cam” refers to a rotatable piece in a mechanical linkage. For example, the cam 212 can rotate about an axis (e.g., not illustrated in FIG. 2A), as is further described herein.

In the orientation illustrated in FIG. 2A, the expansion member 206 can be at a first diameter “D1”, as indicated in FIG. 2A. The disengaged position of the cam 212 can correspond to the expansion member 206 being at the first diameter “D1”.

The cam 212 can move from a disengaged position to an engaged position to cause the compression flange 204 to translate linearly with respect to the cam 212. For example, the cam 212 can rotate (e.g., counterclockwise, as oriented in FIG. 2A) to cause a force to be applied to the shaft flange 210. The force applied to the shaft flange 210 by the cam 212 rotating from the disengaged position to the engaged position can cause the shaft flange 210 (and the compression flange 204) to translate linearly away from the cam 212. Linear translation of the compression flange 204 can axially compress the expansion member 206, as is further described in connection with FIG. 2B.

FIG. 2B is a side view of an example of an apparatus 200 having an expansion member 206 and a cam 212 in an engaged position consistent with the disclosure. The apparatus 200 can include a drive shaft 202, a compression flange 204, an expansion member 206, a shaft flange 210, and a cam 212. The drive shaft 202 can include an axis 203.

As previously described in connection with FIG. 2A, the cam 212 can move (e.g., rotate) from the disengaged position to the engaged position. Rotation of the cam 212 to the engaged position can cause the shaft flange 210 and the compression flange 204 to translate linearly (e.g., to the left, as oriented in FIG. 2B) with respect to the cam 212.

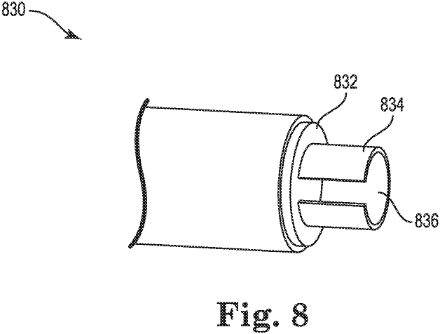

Linear translation of the compression flange 204 can axially compress the expansion member 206. For example, as the compression flange 204 translates to the left, the compression flange 204 can apply linear (and axial) forces to the expansion member 206 to cause the expansion member 206 to expand from the first diameter (e.g., D1) to the second diameter “D2”. In other words, the rotation of the cam 212 from the disengaged position to the engaged position can compress the expansion member 206 such that the expansion member 206 expands from a first diameter “D1” to a second diameter “D2”, where the second diameter “D2” is greater than the first diameter “D1”. When at the second diameter D2, the expansion member 206 can interface with a grip structure of a print cartridge to rotate the print cartridge, as is further described in connection with FIGS. 8-14.

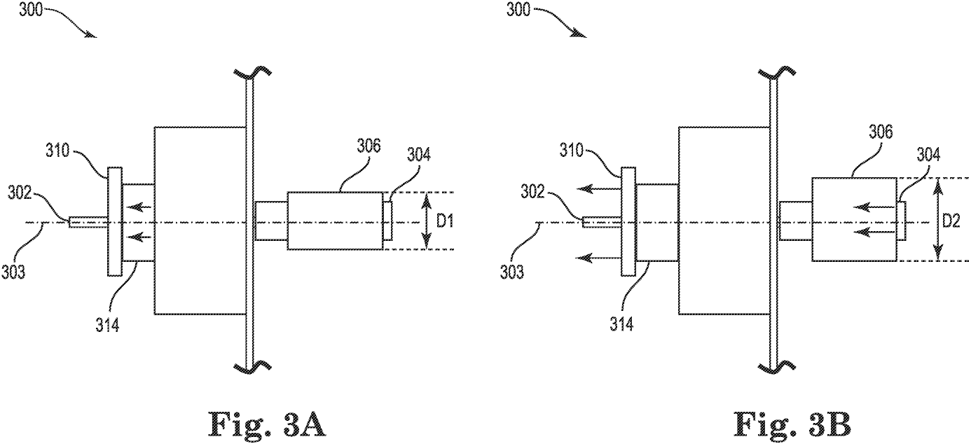

FIG. 3A is a side view of an example of an apparatus 300 having an expansion member 306 and a solenoid 314 in a disengaged position consistent with the disclosure. The apparatus 300 can include a drive shaft 302, a compression flange 304, an expansion member 306, a shaft flange 310, and a solenoid 314. The drive shaft 302 can include an axis 303.

As illustrated in FIG. 3A, the compression mechanism (e.g., compression mechanism 108, previously described in connection with FIG. 1) can be a shaft flange 310 and solenoid 314. As used herein, the term “solenoid” refers to a device that converts electrical energy to mechanical energy. For example, the solenoid 314 can create a magnetic field from electric current to create linear motion. The solenoid 314 can be coaxially located relative to the shaft flange 310.

In the orientation illustrated in FIG. 3A, the expansion member 306 can be at a first diameter “D1”, as indicated in FIG. 3A. The disengaged position of the solenoid 314 can correspond to the expansion member 306 being at the first diameter “D1”.

The solenoid 314 can move from a disengaged position to an engaged position to cause the compression flange 304 to translate linearly with respect to the solenoid 314. For example, the solenoid 314 can translate (e.g., to the left, as oriented in FIG. 3A) to cause a force to be applied to the shaft flange 310. The force applied to the shaft flange 310 by the solenoid 314 translating from the disengaged position to the engaged position can cause the shaft flange 310 (and the compression flange 304) to translate linearly away from the solenoid 314. Linear translation of the compression flange 304 can axially compress the expansion member 306, as is further described in connection with FIG. 3B.

FIG. 3B is a side view of an example of an apparatus 300 having an expansion member 306 and a solenoid 314 in an engaged position consistent with the disclosure. The apparatus 300 can include a drive shaft 302, a compression flange 304, an expansion member 306, a shaft flange 310, and a solenoid 314. The drive shaft 302 can include an axis 303.

As previously described in connection with FIG. 3A, the solenoid 314 can move (e.g., translate) from the disengaged position to the engaged position. Translation of the solenoid 314 to the engaged position can cause the shaft flange 310 and the compression flange 304 to translate linearly (e.g., to the left, as oriented in FIG. 3B) with respect to the solenoid 314.

Linear translation of the compression flange 304 can axially compress the expansion member 306. For example, as the compression flange 304 translates to the left, the compression flange 304 can apply linear (and axial) forces to the expansion member 306 to cause the expansion member 306 to expand from the first diameter (e.g., D1) to the second diameter “D2”. In other words, the translation of the solenoid 314 from the disengaged position to the engaged position can compress the expansion member 306 such that the expansion member 306 expands from a first diameter “D1” to a second diameter “D2”, where the second diameter “D2” is greater than the first diameter “D1”. When at the second diameter D2, the expansion member 306 can interface with a grip structure of a print cartridge to rotate the print cartridge, as is further described in connection with FIGS. 8-14.

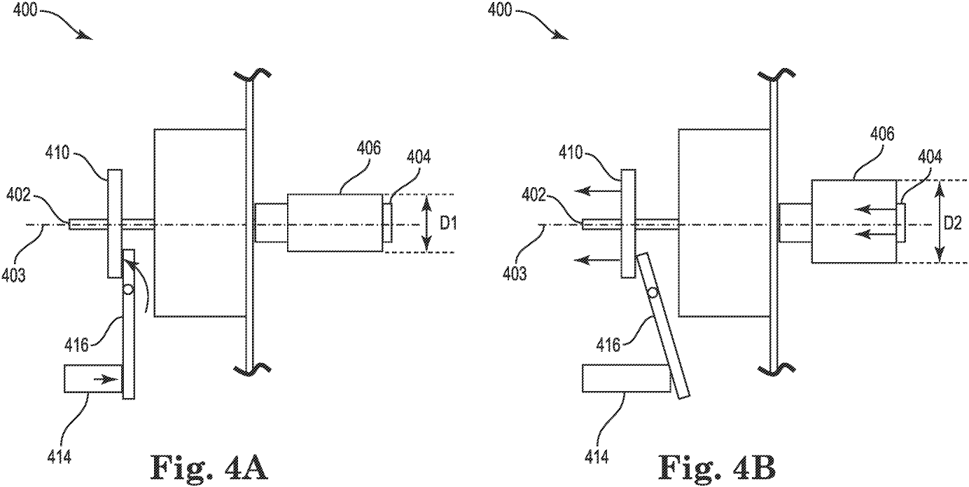

FIG. 4A is a side view of an example of an apparatus 400 having an expansion member 406, a lever 416, and a solenoid 414 in a disengaged position consistent with the disclosure. The apparatus 400 can include a drive shaft 402, a compression flange 404, an expansion member 406, a shaft flange 410, a solenoid 414, and a lever 416. The drive shaft 402 can include an axis 403.

As illustrated in FIG. 4A, the compression mechanism (e.g., compression mechanism 108, previously described in connection with FIG. 1) can be a shaft flange 410, solenoid 414, and a lever 416. The shaft flange 410 can be connected to the drive shaft 402. The solenoid 414 can be spaced apart from the drive shaft 402.

The apparatus 400 can include a lever 416. As used herein, the term “lever” refers to a beam that can pivot at a fixed hinge. For example, the lever 416 can pivot about an axis (e.g., not illustrated in FIG. 4A).

In the orientation illustrated in FIG. 4A, the expansion member 406 can be at a first diameter “D1”, as indicated in FIG. 4A. The disengaged position of the solenoid 414 can correspond to the expansion member 406 being at the first diameter “D1”.

The solenoid 414 can move from a disengaged position to an engaged position to cause the lever 416 to pivot to cause the compression flange 404 to translate linearly with respect to the solenoid 414. For example, the solenoid 414 can translate (e.g., to the right, as oriented in FIG. 4A) to cause a force to be applied to the lever 416, resulting in rotation of the lever 416 (e.g., counterclockwise, as oriented in FIG. 4A) to cause a force to be applied to the shaft flange 410. The force applied to the shaft flange 410 by the solenoid 414 translating from the disengaged position to the engaged position to cause rotation of the lever 416 can cause the shaft flange 410 (and the compression flange 404) to translate linearly to the left (e.g., as oriented in FIG. 4A). That is, actuation of the solenoid 414 can cause the lever 416 to pivot to cause the linear translation of the compression flange 404. Linear translation of the compression flange 404 can axially compress the expansion member 406, as is further described in connection with FIG. 4B.

FIG. 4B is a side view of an example of an apparatus 400 having an expansion member 406, a lever 416, and a solenoid 414 in an engaged position consistent with the disclosure. The apparatus 400 can include a drive shaft 402, a compression flange 404, an expansion member 406, a shaft flange 410, a solenoid 414, and a lever 416. The drive shaft 402 can include an axis 403.

As previously described in connection with FIG. 4A, the solenoid 414 can move (e.g., translate) from the disengaged position to the engaged position. Translation of the solenoid 414 to the engaged position can cause the lever 416 to pivot to cause the shaft flange 410 and the compression flange 404 to translate linearly (e.g., to the left, as oriented in FIG. 4B).

Linear translation of the compression flange 404 can axially compress the expansion member 406. For example, as the compression flange 404 translates to the left, the compression flange 404 can apply linear (and axial) forces to the expansion member 406 to cause the expansion member 406 to expand from the first diameter (e.g., D1) to the second diameter “D2”. In other words, the translation of the solenoid 414 from the disengaged position to the engaged position can cause the lever 416 to pivot to compress the expansion member 406 such that the expansion member 406 expands from a first diameter “D1” to a second diameter “D2”, where the second diameter “D2” is greater than the first diameter “D1”. When at the second diameter D2, the expansion member 406 can interface with a grip structure of a print cartridge to rotate the print cartridge, as is further described in connection with FIGS. 8-14.

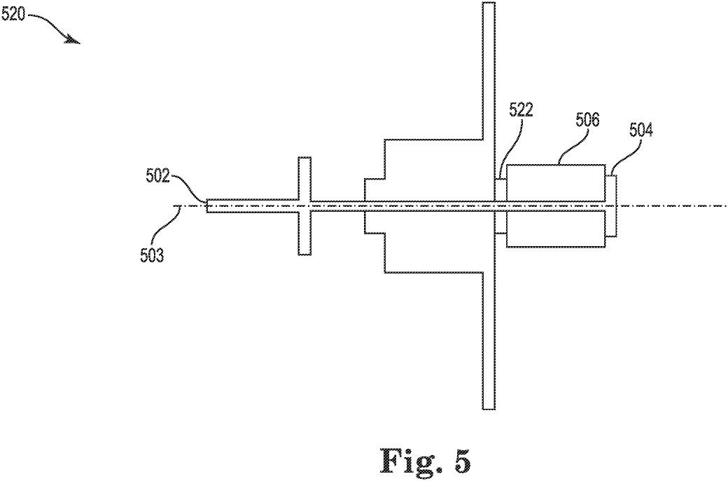

FIG. 5 is a side section view of an example of a portion of an imaging device 520 having an expansion member 506 consistent with the disclosure. The portion of the imaging device 520 can include a drive shaft 502, a compression flange 504, an expansion member 506, and a compression nut 522. The drive shaft 502 can include an axis 503.

As illustrated in FIG. 5, the portion of the imaging device 520 can include a drive shaft 502. The compression flange 504 can be coaxial with the axis 503 of the drive shaft 502.

The portion of the imaging device 520 can include an expansion member 506. The expansion member 506 can be compressed axially to expand its diameter from a first diameter to a second diameter via a compression mechanism. For example, the compression mechanism can cause the expansion member to expand from the first diameter to the second diameter. In some examples, the compression mechanism can include a compression nut 522, as is further described herein.

As illustrated in FIG. 5, the portion of the imaging device 520 can include a compression nut. As used herein, the term “compression nut” refers to a fastener utilized to compress an expansion member. For example, the expansion member 506 can be compressed between the compression flange 504 and the compression nut 522. The compression nut 522 can be coaxial with the axis 503 and be located proximate to the expansion member 506.

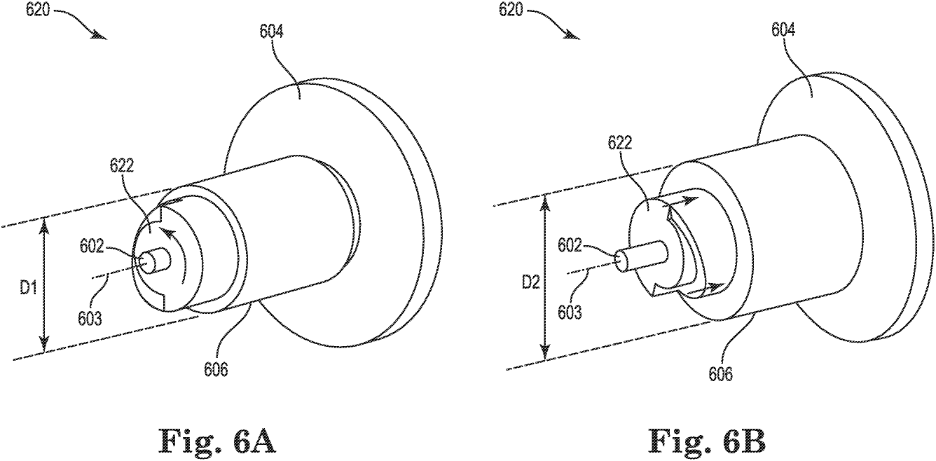

FIG. 6A is a perspective view of an example of an apparatus 620 having an expansion member 606 and a compression nut 622 in a disengaged position consistent with the disclosure. The apparatus 620 can include a drive shaft 602, a compression flange 604, an expansion member 606, and a compression nut 622. The drive shaft 602 can include an axis 603.

As illustrated in FIG. 6A, the compression mechanism (e.g., compression mechanism 108, previously described in connection with FIG. 1) can be a compression nut 622. As illustrated in FIG. 6A, the compression nut 622 can include a beveled guide surface. For example, the beveled guide surface can be an area of the compression nut 622 that is inclined in order to assist a part of another device along the inclined area. For example, although not illustrated in FIG. 6A, another device can interface with the compression nut 622 (e.g., and the beveled guide surface). The another device can cause the compression nut 622 to rotate about the axis 603.

The compression nut 622 can move from a disengaged position to an engaged position to compress the expansion member 606 against the compression flange 604. For example, the compression nut 622 can rotate (e.g., counterclockwise, as oriented in FIG. 6A) about the axis 603 to translate linearly (e.g., to the right, as oriented in FIG. 6B) with respect to the drive shaft 602 to cause a force to be applied to the expansion member 606. Linear translation of the compression nut 622 can axially compress the expansion member 606, as is further described in connection with FIG. 4B.

Although not illustrated in FIG. 6A, in some examples the drive shaft 602 can be threaded. The compression nut 622 can engage with the threads on the drive shaft 602 such that when rotated, the compression nut 622 can translate linearly towards the compression flange 604.

FIG. 6B is a perspective view of an example of an apparatus 620 having an expansion member 606 and a compression nut 622 in an engaged position consistent with the disclosure. The apparatus 620 can include a drive shaft 602, a compression flange 604, an expansion member 606, and a compression nut 622. The drive shaft 602 can include an axis 603.

As previously described in connection with FIG. 6A, the compression nut 622 can move (e.g., rotate about the axis 603 to translate linearly with respect to the axis 603) from the disengaged position to the engaged position. Linear translation of the compression nut 622 can axially compress the expansion member 606. For example, as the compression nut 622 rotates about the axis 603 to translates to the right, the compression nut 622 can apply linear (and axial) forces to the expansion member 606 compress the expansion member 606 against the compression flange 604 to cause the expansion member 606 to expand from the first diameter (e.g., D1) to the second diameter “D2”. In other words, the translation of the compression nut 622 from the disengaged position to the engaged position can compress the expansion member 606 into the compression flange 604 such that the expansion member 606 expands from a first diameter “D1” to a second diameter “D2”, where the second diameter “D2” is greater than the first diameter “D1”. When at the second diameter D2, the expansion member 606 can interface with a grip structure of a print cartridge to rotate the print cartridge, as is further described in connection with FIGS. 8-14.

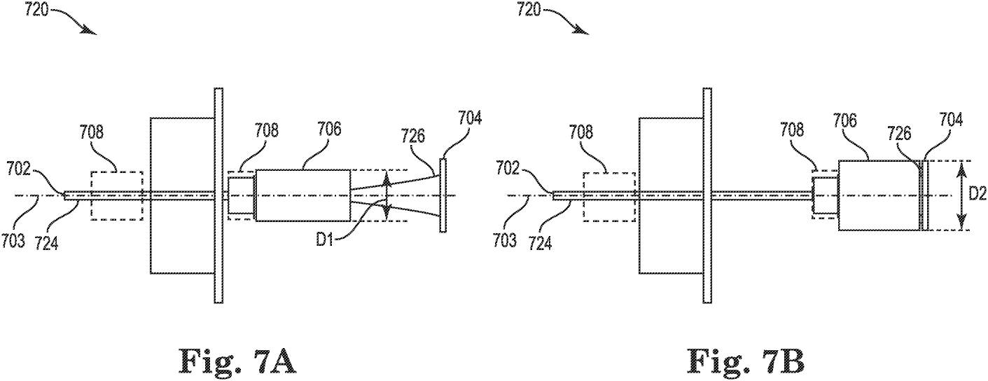

FIG. 7A is a side view of an example of an apparatus 720 having a drive shaft 702 with a tapered diameter and an expansion member 706 consistent with the disclosure. The apparatus 720 can include a drive shaft 702, a compression flange 704, an expansion member 706, and a compression mechanism 708. The drive shaft 402 can include an axis 403, a first end 724, and a second end 726.

As illustrated in FIG. 7A, the apparatus 720 can include a compression mechanism 708. The compression mechanism 708 can be, for example, a cam, a solenoid, a solenoid and a lever, and/or a compression nut to be utilized in combination with the drive shaft 724 having the tapered diameter, as is further described herein.

The drive shaft 702 can include a tapered diameter. For example, the diameter of the drive shaft 702 can taper from a first end 724 having a first diameter to a second end 726 having a second diameter. The second diameter of the second end 726 can be larger than the first diameter of the first end 724. In other words, the diameter of the drive shaft 702 can get larger from the first end 724 to the second end 726. The compression flange 704 can be located proximate to the second end 726.

The compression mechanism 708 can cause the expansion member 706 to translate linearly relative to the drive shaft 702 towards the second end 726 of the drive shaft 702 to cause the expansion member 706 to expand from the first diameter “D1” to the second diameter “D2”. For example, the compression mechanism 708 (e.g., a cam, a solenoid, a solenoid and a lever, and/or a compression nut utilizing the methods previously described in connection with FIGS. 2-6, respectively) can move from a disengaged position to an engaged position to cause the expansion member 706 to translate towards the second end 726 of the drive shaft 702.

FIG. 7B is a side view of an example of an apparatus 720 having a drive shaft with a tapered diameter and an expansion member consistent with the disclosure. The apparatus 720 can include a drive shaft 702, a compression flange 704, an expansion member 706, and a compression mechanism 708. The drive shaft 402 can include an axis 403, a first end 724, and a second end 726.

As previously described in connection with FIG. 7A, the compression mechanism 708 can move (e.g., translate) from the disengaged position to the engaged position. Translation of the compression mechanism 708 to the engaged position can cause the expansion member 706 to translate linearly (e.g., to the right, as oriented in FIG. 7B).

Linear translation of the expansion member 706 can cause the diameter of the expansion member 706 to expand as it slides over the increasing diameter of the drive shaft 702 as it translates towards the second end 726 of the drive shaft 702. For example, as the expansion member 706 translates to the right, the increasing diameter of the drive shaft 702 can stretch the diameter of the expansion member 706 from the first diameter (e.g., D1) to the second diameter “D2”. In other words, the translation of the expansion member 706 from the disengaged position to the engaged position can cause the expansion member 706 to translate toward the second end 726 to stretch the expansion member 706 such that the expansion member 706 expands from a first diameter “D1” to a second diameter “D2”, where the second diameter “D2” is greater than the first diameter “D1”. When at the second diameter D2, the expansion member 706 can interface with a grip structure of a print cartridge to rotate the print cartridge, as is further described in connection with FIGS. 8-14.

FIG. 8 is a perspective view of an apparatus 830 having a cartridge flange 832 and a grip structure 834 consistent with the disclosure. The grip structure 834 can include an inner surface 836.

The apparatus 830 can be included on a print cartridge. For example, the print cartridge may be interfaced with an imaging device such that the imaging device can utilize the print cartridge during a print job, as is further described in connection with FIG. 9.

The apparatus 830 can include a cartridge flange 832. For example, the cartridge flange 832 can be a projecting collar of material. The cartridge flange 832 can be connected to a print cartridge.

The apparatus 830 can include a grip structure 834. As used herein, the term “grip structure” refers to a part or parts arranged together to accomplish a purpose. For example, the grip structure 834 can interface with an expansion member. The expansion member can expand from a first diameter to a second diameter, where the grip structure 834 can receive the expansion member, as is further described in connection with FIGS. 9-14.

The grip structure 834 can be oriented substantially normal to the cartridge flange 832. As used herein, the term “substantially” intends that the characteristic does not have to be absolute but is close enough so as to achieve the characteristic. For example, “substantially normal” is not limited to absolute normal. For instance, the grip structure 834 can be within 0.5°, 1°, 2°, 5°, etc. of absolutely normal.

Although the grip structure 834 is described above as being oriented substantially normal to the cartridge flange 832, examples of the disclosure are not so limited. For example, the grip structure 834 may be angled based on a shape of the expansion member. For instance, the expansion member may be cone shaped, and the grip structure 834 may be accordingly angled based on the cone shape of the expansion member, among other examples.

The grip structure 834 can include an inner surface 836. The inner surface 836 can be a surface which interfaces with an outer surface of an expansion member. For example, a friction fit can occur between the inner surface 836 and an outer surface of an expansion member in order to transmit torque between the expansion member and the grip structure 834/print cartridge, as is further described with respect to FIGS. 9A and 9B.

In some examples, the inner surface 836 can include striations. As used herein, the term “striation” refers to a series of ridges furrows, grooves, scratches, channels, or other marks in a surface in order to increase a coefficient of friction of the surface relative to the surface being smooth. For example, the striations of the inner surface 836 can better grip an external surface of an expansion member in order to transmit torque between the expansion member and the grip structure 834/print cartridge, as is further described with respect to FIGS. 9A and 9B.

In some examples, the inner surface 836 can include a coarse surface. As used herein, the term “coarse surface” refers to a surface with a rough texture in order to increase a coefficient of friction of the surface relative to the surface being smooth. For example, the coarse surface of the inner surface 836 can better grip an external surface of an expansion member in order to transmit torque between the expansion member and the grip structure 834/print cartridge, as is further described with respect to FIGS. 9A and 9B. The coarse surface can be machined and/or added (e.g., via fasteners, adhesives, etc.)

FIG. 9A is a side section view of an example of a system 940 consistent with the disclosure. The system 940 can include an imaging device 942 and a print cartridge 944.

As illustrated in FIG. 9A, the system 940 can include an imaging device 942. The imaging device 942 can include a drive shaft 902, a compression flange 904, and an expansion member 906 located proximate to the compression flange 904. Although not illustrated in FIG. 9A, the imaging device 942 can include a compression mechanism.

The system 940 can include a print cartridge 944. The print cartridge 944 can include a cartridge flange 932 and a grip structure 934. The grip structure 934 can be shaped to receive the expansion member 906, as is further described herein.

Print cartridges may be removed from imaging devices for various reasons. For example, the print cartridge 944 may be removed from the imaging device 942 for maintenance, replacement, cleaning, etc. Following such removal, the print cartridge 944 may be interfaced with the imaging device 942, as is further described herein.

As illustrated in FIG. 9A, the expansion member 906 can be at a first diameter D1. The expansion member 906 being at the first diameter D1 can allow a user to position the print cartridge 944 in the imaging device 942 such that the expansion member 906 can be located in the grip structure 934.

When the print cartridge 944 is positioned in the imaging device 942 and ready to be interfaced, a compression mechanism (e.g., compression mechanism 108, 708, previously described in connection with FIGS. 1 and 7, respectively) can cause the expansion member 906 to expand from the first diameter D1 to a second diameter D2. For example, as previously described in connection with FIGS. 2-6, the compression mechanism can include a cam, a solenoid, a solenoid and a lever, a compression nut, and/or a tapered drive shaft, which can move from a disengaged position to an engaged position to cause the expansion member to expand from the first diameter “D1” to the second diameter “D2”.

FIG. 9B is a side section view of an example of a system 940 consistent with the disclosure. The system 940 can include an imaging device 942 and a print cartridge 944.

As previously described in connection with FIG. 9A, a compression mechanism can cause the expansion member 906 to expand from a first diameter “D1” to the second diameter “D2”. The grip structure 934 can receive the expansion member 906 in response to the expansion member 906 expanding from the first diameter “D1” to the second diameter “D2”.

A friction fit can be created between the inner surface of the grip structure 934 and an outer surface of the expansion member 906 in response to the expansion member 906 expanding to the second diameter “D2”. For example, the inner surface of the grip structure 934 can include a coefficient of friction and the outer surface of the expansion member 906 can include a coefficient of friction such that when they come into contact (e.g., as a result of the expansion of the expansion member 906 to the second diameter “D2”), they do not move relative to each other when rotated.

As a result of the friction fit, torque can be transmitted from the expansion member 906 to the print cartridge 944 via the friction fit in response to rotation of the drive shaft 902. For example, the imaging device 942 may include instructions to rotate the print cartridge 944 during a print job. Accordingly, as illustrated in FIG. 9B, the drive shaft 902 can be rotated (e.g., in a direction “into” the page as oriented in FIG. 9B). As a result of the friction fit between the expansion member 906 and the grip structure 934, torque can be transmitted from the imaging device 942 via the expansion member 906 and the grip structure 934 to the print cartridge 944 via the friction fit therebetween in response to rotation of the drive shaft 902.

In some examples, the material of the expansion member 906 can be chosen such that in response to an applied torque exceeding a threshold torque, the expansion member 906 can slip relative to the inner surface of the grip structure 934 (e.g., when the coefficient of friction is overcome in response to the threshold torque being exceeded). For instance, the expansion member 906 can be a rubber elastomer such that if the imaging device 942 attempts to apply a torque to rotate the print cartridge 944 that exceeds a threshold torque, the rotation of the drive shaft 902 can cause the expansion member 906 to rotate relative to the grip structure 934, preventing the print cartridge 944 from rotating. Such a material can be chosen for the expansion member 906 in order to avoid damaging the imaging device 942 and/or the print cartridge 944 in the event a part (e.g., in the imaging device 942, or associated with the print cartridge 944) is jammed.

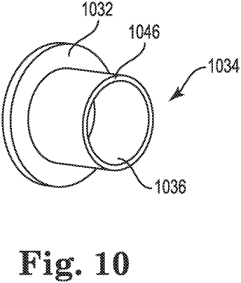

FIG. 10 is a perspective view of an example of a grip structure 1034 including a circular reception member 1046 consistent with the disclosure. As illustrated in FIG. 10, the grip structure 1034 can be connected to a cartridge flange 1032 and include an inner surface 1036.

The grip structure 1034 can include a circular reception member 1046. As used herein, the term “reception member” refers to a constituent component of a composite whole to receive an expansion member. For example, the circular reception member 1046 can be circularly shaped in order to receive an expansion member. When the expansion member is expanded from the first diameter to the second diameter, the expansion member can interface with the circular reception member 1046. For example, the inner surface 1036 of the circular reception member 1046 can provide a friction fit between the inner surface 1036 and the expansion member to transmit torque from the expansion member to the print cartridge.

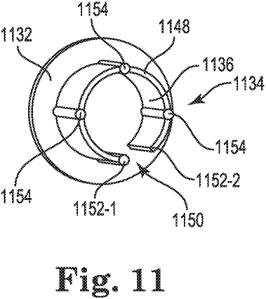

FIG. 11 is a perspective view of an example of a grip structure 1134 including a semi-circular reception member 1148 consistent with the disclosure. As illustrated in FIG. 11, the grip structure 1134 can be connected to a cartridge flange 1132 and include an inner surface 1136.

The grip structure 1134 can include a semi-circular reception member 1148. As used herein, the term “semi-circular” refers to a portion of a circle shape that is less than 360°. For example, the semi-circular reception member 1148 can be shaped as a semi-circle in order to receive an expansion member. When the expansion member is expanded from the first diameter to the second diameter, the expansion member can interface with the semi-circular reception member 1148. For example, the inner surface 1136 of the semi-circular reception member 1148 can provide a friction fit between the inner surface 1136 and the expansion member to transmit torque from the expansion member to the print cartridge.

The semi-circular reception member 1148 can include a space 1150. The space 1150 can be defined by end points 1152-1 and 1152-2 of the semi-circular reception member 1148. In response to the expansion of the expansion member to the second diameter, the end points 1152-1 and 1152-2 can transmit torque from the expansion member to the apparatus. For example, as the expansion member expands to the second diameter, a portion of the expansion member can “spill out/be forced out of” of the space 1150 such that the expansion member forms an irregular shape when expanded to the second diameter. As a result, the portion of the expansion member that protrudes from the space 1150 can apply forces (e.g., radial, tangential, and/or axial forces) on the grip structure 1134 to transmit torque from the expansion member to the print cartridge.

In some examples, the semi-circular reception member 1148 can include a plurality of circular extruded members 1154. The plurality of circular extruded members 1154 can be integrally formed with the semi-circular reception member 1148. The plurality of circular extruded members 1154 can form protrusions on the inner surface 1136 of the grip structure 1134 to assist in providing a friction fit between the inner surface 1136 and the expansion member to transmit torque from the expansion member to the print cartridge.

Although the extruded members 1154 are illustrated in FIG. 11 as being circular, examples of the disclosure are not so limited. For example, the extruded members 1154 can be square, rectangular, triangular, any other shape and/or combinations thereof. Further, the extruded members 1154 can include protrusions from the surface of the extruded members 1154 to further assist in providing a friction fit between the inner surface 1136 and the expansion member.

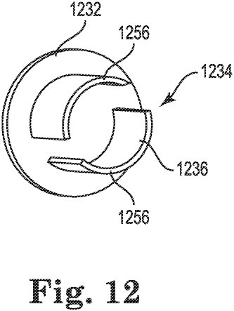

FIG. 12 is a perspective view of an example of a grip structure 1234 including a plurality of semi-circular reception members 1256 consistent with the disclosure. As illustrated in FIG. 12, the grip structure 1234 can be connected to a cartridge flange 1232 and include inner surfaces 1236.

The grip structure 1234 can include a plurality of semi-circular reception members 1256. For example, the plurality of semi-circular reception members 1256 can be shaped as semi-circles in order to receive an expansion member. When the expansion member is expanded from the first diameter to the second diameter, the expansion member can interface with the plurality of semi-circular reception members 1256. For example, the inner surfaces 1236 of the plurality of semi-circular reception members 1256 can provide a friction fit between the inner surfaces 1236 and the expansion member to transmit torque from the expansion member to the print cartridge.

Similar to the semi-circular reception member 1148 previously described in connection with FIG. 11, the plurality of semi-circular reception members 1256 can include spaces between the semi-circular reception members 1256. In response to the expansion of the expansion member to the second diameter, the end points defining the spaces between the plurality of semi-circular reception members 1256 can transmit torque from the expansion member to the apparatus. For example, as the expansion member expands to the second diameter, portions of the expansion member can “spill out/be forced out of” of the spaces such that the expansion member forms an irregular shape when expanded to the second diameter. As a result, the portion of the expansion member that protrudes from the spaces between the plurality of semi-circular reception members 1256 can apply forces (e.g., radial, tangential, and/or axial forces) on the grip structure 1234 to transmit torque from the expansion member to the print cartridge.

Although not illustrated in FIG. 12, the plurality of semi-circular reception members 1256 can include a plurality of extruded members. The plurality of extruded members can be circular, square, rectangular, triangular, and/or any other shape and/or combinations thereof and can be integrally formed with the plurality of semi-circular reception members 1256. The plurality of extruded members can form protrusions on the inner surfaces 1236 of the grip structure 1234 to assist in providing a friction fit between the inner surfaces 1236 and the expansion member to transmit torque from the expansion member to the print cartridge.

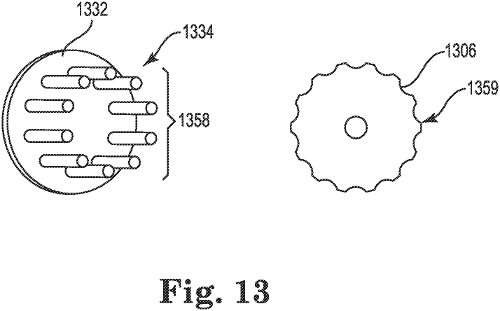

FIG. 13 is a perspective view of an example of a grip structure 1334 including a plurality of circular extruded members 1358 consistent with the disclosure. As illustrated in FIG. 13, the grip structure 1334 can be connected to a cartridge flange 1332.

The grip structure 1334 can include a plurality of circular extruded members 1358. As used herein, the term “extruded member” refers to a member that protrudes from a base. For example, the plurality of circular extruded members 1358 can protrude from the cartridge flange 1332 and can be oriented around an axis of the print cartridge to receive an expansion member in response to the print cartridge being connected to an imaging device. When the expansion member is expanded from the first diameter to the second diameter, the expansion member can interface with the plurality of circular extruded members 1358. For example, the plurality of circular extruded members 1358 can provide a friction fit between the plurality of circular extruded members 1358 and the expansion member to transmit torque from the expansion member to the print cartridge.

As illustrated in FIG. 13, the plurality of circular extruded members 1358 can include spaces between each circular extruded member. Accordingly, as the expansion member expands to the second diameter, portions of the expansion member can “spill out/be forced out of” of the spaces between the plurality of circular extruded members 1358. As a result, the expansion member can be formed into a gear shape with the portions protruding from the spaces between the plurality of circular extruded members 1358 acting as gear teeth. As a result, the portions of the expansion member that protrude from the spaces between the plurality of circular extruded members 1358 can apply forces (e.g., radial, tangential, and/or axial forces) on the grip structure 1334 to transmit torque from the expansion member to the print cartridge.

In some examples, the expansion member 1306 can include a gear shaped cross section. The gear teeth 1359 of the expansion member can be complementarily shaped with the plurality of circular extruded members 1358. For example, the gear teeth 1359 can be shaped to fit within the plurality of circular extruded members 1358. Accordingly, as the expansion member 1306 expands to the second diameter, the gear teeth 1359 of the expansion member 1306 can mesh with the spaces between the plurality of circular extruded members 1358. As a result, the gear teeth 1359 of the expansion member 1306 that protrude from the spaces between the plurality of circular extruded members 1358 can apply forces (e.g., radial, tangential, and/or axial forces) on the grip structure 1334 to transmit torque from the expansion member to the print cartridge.

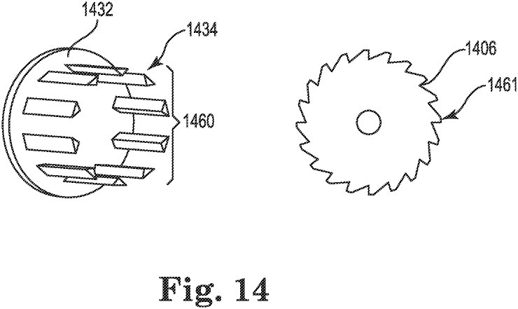

Although the expansion member 1306 with a gear shaped cross section having gear teeth 1359 is shown in FIG. 13 as interfacing with the grip structure 1334 having the plurality of circular extruded members 1358, examples of the disclosure are not so limited. For example, the expansion member 1306 with the gear shaped cross section having gear teeth 1359 can interface with any other grip structure. For instance, the expansion member 1306 with the gear shaped cross section having gear teeth 1359 can interface with the semi-circular grip structure 884 (e.g., previously described in connection with FIG. 8), the circular reception member 1046 (e.g., previously described in connection with FIG. 10), the semi-circular reception member 1148 (e.g., previously described in connection with FIG. 11), the plurality of circular reception members 1256 (e.g., previously described in connection with FIG. 12), the plurality of triangular extruded members 1460 (e.g., described in connection with FIG. 14), and/or any other shaped reception member.

FIG. 14 is a perspective view of an example of a grip structure 1434 including a plurality of triangular extruded members 1460 consistent with the disclosure. As illustrated in FIG. 14, the grip structure 1434 can be connected to a cartridge flange 1432.

The grip structure 1434 can include a plurality of triangular extruded members 1460. For example, the plurality of triangular extruded members 1460 can protrude from the cartridge flange 1432 and can be oriented around an axis of the print cartridge to receive an expansion member in response to the print cartridge being connected to an imaging device. When the expansion member is expanded from the first diameter to the second diameter, the expansion member can interface with the plurality of triangular extruded members 1460. For example, the plurality of triangular extruded members 1460 can provide a friction fit between the plurality of triangular extruded members 1460 and the expansion member to transmit torque from the expansion member to the print cartridge.

As illustrated in FIG. 14, the plurality of triangular extruded members 1460 can include spaces between each triangular extruded member. Accordingly, as the expansion member expands to the second diameter, portions of the expansion member can “spill out/be forced out of” of the spaces between the plurality of triangular extruded members 1460. As a result, the expansion member can be formed into a gear shape with the portions protruding from the spaces between the plurality of triangular extruded members 1460 acting as gear teeth. As a result, the portions of the expansion member that protrude from the spaces between the plurality of triangular extruded members 1460 can apply forces (e.g., radial, tangential, and/or axial forces) on the grip structure 1434 to transmit torque from the expansion member to the print cartridge.

In some examples, the expansion member 1406 can include a gear shaped cross section. The gear teeth 1461 of the expansion member 1406 can be complementarily shaped with the plurality of triangular extruded members 1434. For example, the gear teeth 1461 can be shaped to fit within the plurality of triangular extruded members 1460. Accordingly, as the expansion member 1406 expands to the second diameter, the gear teeth 1461 of the expansion member 1406 can mesh with the spaces between the plurality of triangular extruded members 1434. As a result, the gear teeth 1461 of the expansion member 1406 that protrude from the spaces between the plurality of triangular extruded members 1434 can apply forces (e.g., radial, tangential, and/or axial forces) on the grip structure 1434 to transmit torque from the expansion member to the print cartridge.

Although the expansion member 1406 with a gear shaped cross section having gear teeth 1460 is shown in FIG. 14 as interfacing with the grip structure 1434 having the plurality of triangular extruded members 1460, examples of the disclosure are not so limited. For example, the expansion member 1406 with the gear shaped cross section having gear teeth 1460 can interface with any other grip structure. For instance, the expansion member 1406 with the gear shaped cross section having gear teeth 1460 can interface with the semi-circular grip structure 884 (e.g., previously described in connection with FIG. 8), the circular reception member 1046 (e.g., previously described in connection with FIG. 10), the semi-circular reception member 1148 (e.g., previously described in connection with FIG. 11), the plurality of circular reception members 1256 (e.g., previously described in connection with FIG. 12), the plurality of circular extruded members 1346 (e.g., previously described in connection with FIG. 13), and/or any other shaped reception member.

Expansion members, according to the disclosure, can allow for a print cartridge to easily align with and interface with an imaging device by utilizing a member that expands to interact with a grip structure of the print cartridge. A friction fit created between the expansion member and the grip structure can allow for rotation of the print cartridge during a print job while reducing chances for jams to damage the print cartridge and/or the imaging device, as the friction fit can be specified such that the expansion member can slip relative to the grip structure if a threshold torque is exceeded.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 202 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. An apparatus, comprising:
a drive shaft;
a compression flange;
an expansion member located proximate to the compression flange; and
a compression mechanism, wherein the compression mechanism is to cause the expansion member to expand from a first diameter to a second diameter.

2. The apparatus of claim 1, wherein the compression mechanism includes a shaft flange connected to the drive shaft and a cam.

3. The apparatus of claim 2, wherein:
the cam is to move from a disengaged position to an engaged position to cause the compression flange to translate linearly with respect to the cam; and
linear translation of the compression flange is to axially compress the expansion member to cause the expansion member to expand from the first diameter to the second diameter.

4. The apparatus of claim 1, wherein the compression mechanism includes a shaft flange connected to the drive shaft and a solenoid.

5. The apparatus of claim 4, wherein:
the solenoid is to actuate from a disengaged position to an engaged position to cause the compression flange to translate linearly with respect to the cam; and
linear translation of the compression flange is to axially compress the expansion member to cause the expansion member to expand from the first diameter to the second diameter.

6. The apparatus of claim 5, wherein the solenoid is coaxially located relative to the shaft flange.

7. The apparatus of claim 5, wherein the solenoid actuating from the disengaged position to the engaged position is to cause a lever to pivot to cause the linear translation of the compression flange.

8. The apparatus of claim 1, wherein the drive shaft, the compression flange, and the expansion member are coaxially located relative to each other.

9. An imaging device, comprising:
a drive shaft;
a compression flange, wherein the compression flange is coaxial with an axis of the drive shaft;
an expansion member;
a compression nut coaxial with the axis and located proximate to the expansion member, wherein the compression nut is spaced apart from the compression flange; and
a compression mechanism, wherein the compression mechanism is to cause the expansion member to expand from a first diameter to a second diameter.

10. The imaging device of claim 9, wherein the compression nut is to rotate about the axis to translate linearly with respect to the drive shaft from a disengaged position to an engaged position to compress the expansion member against the compression flange such that the expansion member expands from the first diameter to the second diameter.

11. The imaging device of claim 9, wherein the drive shaft includes a diameter that tapers from a first end having a first diameter to a second end having a second diameter, wherein:
the compression flange is located proximate to the second end; and
the second diameter is larger than the first diameter.

12. The imaging device of claim 11, wherein the compression mechanism is to cause the expansion member to translate linearly relative to the drive shaft to the second end of the drive shaft to cause the expansion member to expand from the first diameter to the second diameter.

13. A system, comprising:
an imaging device, including:
a drive shaft;
a compression flange;
an expansion member located proximate to the compression flange; and
a compression mechanism, wherein the compression mechanism is to cause the expansion member to expand from a first diameter to a second diameter;
a print cartridge, including:
a cartridge flange; and
a grip structure to receive the expansion member in response to the expansion member expanding from the first diameter to the second diameter.

14. The system of claim 13, wherein a friction fit is created between an inner surface of the grip structure and an outer surface of the expansion member in response to the expansion member expanding to the second diameter.

15. The system of claim 14, wherein torque is to be transmitted from the expansion member to the print cartridge via the friction fit in response to rotation of the drive shaft.
